(19) United States
(12) Patent Application Publication
(10) Pub. No.: US 2026/0116662 A1
(43) Pub. Date: Apr. 30, 2026

(54) AUTOMATED STORAGE SYSTEM COMPRISING A SHUTTLE FOR TRANSPORTING STORAGE AIDS

(71) Applicant: KNAPP AG, Hart bei Graz (AT)

(72) Inventors: Franz MATHI, Hart bei Graz (AT); Marc PENDL, Hart bei Graz (AT); Franz HORNHOFER, Hart bei Graz (AT)

(21) Appl. No.: 19/118,443

(22) PCT Filed: Aug. 21, 2023
(86) PCT No.: PCT/AT2023/060283

§ 371 Date: Apr. 4, 2025

(30) Foreign Application Priority Data
Oct. 6, 2022 (AT) A 50777/2022

(51) Int. Cl. B65G 1/06; B60B 15/00

(52) U.S. Cl. CPC B65G 1/065; B60B 15/00

(57) ABSTRACT

An automated storage system including a shuttle and a rack having several rack supports, the shuttle operable to vertically ascend the rack on two adjacent rack supports by a frictional connection, the shuttle including: ground contact wheels; a load handling device; two motor-driven friction wheels arranged in a friction wheel gauge for vertical friction wheel climbing; and a first pair of counterpressure wheels, and the counterpressure wheels are displaceable by a shuttle control between a docking position and a climbing position, and the shuttle is coupled to the two adjacent rack supports in the climbing position and the shuttle is detached from the two adjacent rack supports in the docking position and, in the climbing position, the counterpressure wheel gauge corresponds to the friction wheel gauge, and one rack support each is arranged at least in sections between one of the friction wheels and one of the counterpressure wheels.

### BACKGROUND

The invention relates to an automated storage system having the features of the preamble of claim 1.

Automated storage systems are known in the field of warehouse logistics for automatically storing goods in a warehouse store and retrieving them therefrom. Such storage systems are used in modern logistics to allow purchase orders to be fulfilled swiftly, quickly and individually. For this purpose, storage systems usually comprise means for picking goods in order to process purchase orders that comprise a variety of different products. However, such storage systems are also used as warehouses, e.g., in the automotive industry, where, for example, a large number of different components have to be stored in a common warehouse and must be available at short notice.

In the prior art, storage systems are known which are designed in the form of high-bay rackings. Therein, goods are stored in storage spaces that are formed by the racks. Such storage systems usually comprise so-called stacker cranes or shuttles which perform the storage and retrieval of goods in and out of the storage spaces.

As part of the storage and retrieval of the goods in and out of the storage spaces, the goods are transported vertically along the rack supports of the racks. This can be done, for example, directly by the shuttles, which, to this end, ascend the rack supports. In the course of this, the respective shuttle is conventionally coupled into the respective rack support, ascending it using, for example, a chain or gear drive engaging the rack support. A disadvantage of such systems is that the manufacturing costs of the entire storage system are increased as a result of the adjustments necessary for this purpose or, respectively, the special shaping of the rack supports. In addition, such systems are associated with high wear and tear, whereby operating costs are increased. Furthermore, in such systems, a coupling-in area is provided in the area of a subsurface beneath the racks, with the rack supports being specially shaped in the coupling-in area in order to enable the shuttles to be latched or, respectively, coupled to the rack supports.

U.S. Pat. No. 10,730,696 B2 discloses a storage system comprising several racks and shuttles, wherein the shuttles are vertically movable on the rack supports.

EP 3 960 658 A1 discloses a charging vehicle for a stack storage arrangement, with the undercarriage of the charging vehicle having two wheel assemblies, wherein the charging vehicle is movable in a first direction with the aid of the first wheel assembly and in a second direction transversely or perpendicularly to the first direction with the aid of the second wheel assembly.

EP 3 992 115 A1 discloses a shuttle for horizontal and vertical travel in a rack system, which has a vertical wing with a pivot axis so as to pivot two rotatable wheel axles of the shuttle's rotatable wheels about the pivot axis between two positions.

EP 3 943 417 A1 discloses a warehouse robot for storing and retrieving goods in and from a high-bay warehouse, respectively, comprising a climbing component slidably connected to a lower frame of the robot.

EP 3 901 067 A1 discloses a transport device for picking items on horizontal and vertical tracks in large racks within warehouses, the transport device consisting of a vehicle body, a travelling mechanism and crawling assemblies.

WO 2022/109452 A2 discloses automated vehicles for use in a storage system for storing loads in levels arranged vertically on top of each other in racks with rack supports. On the automated vehicles, one pair of wheels each is rotatably mounted to the undercarriage, and a motor serves for driving the wheel pair.

US 2021/0047112 A1 discloses a vehicle that is movable along a horizontal surface to a position next to a movable track in a material handling system.

WO 2023/001449 A1 discloses a motorized vehicle intended to transport a load and comprising at least three wheels capable of pivoting by at least 90°.

### BRIEF SUMMARY

The object of the present invention is to provide an automated storage system which avoids the disadvantages of the prior art.

According to the invention, this object is achieved by providing an automated storage system having the features of claim 1.

The automated storage system according to the invention comprises a shuttle for transporting storage aids and at least one rack placed on a subsurface and comprising several rack supports. The shuttle is designed for moving on the subsurface and for vertically ascending the rack on two adjacent rack supports by means of a frictional connection. In addition, the shuttle comprises a plurality of ground contact wheels for moving the shuttle on the subsurface and at least one load handling device for receiving the storage aid. Furthermore, the shuttle comprises two motor-driven friction wheels arranged in a friction wheel gauge for vertical friction wheel climbing on vertical surfaces of the two adjacent rack supports of the rack, and a first pair of counterpressure wheels.

The counterpressure wheels are displaceable by a shuttle control of the shuttle between a docking position and a climbing position, wherein the shuttle is coupled to the two adjacent rack supports in the climbing position and the shuttle is detached from the two adjacent rack supports in the docking position. In the climbing position, the counterpressure wheels are arranged in a counterpressure wheel gauge essentially corresponding to the friction wheel gauge. In the climbing position, one rack support each is arranged at least in sections between one of the friction wheels and one of the counterpressure wheels. In the docking position, the counterpressure wheels are furthermore positioned out of engagement with the rack supports.

As a result of the shuttle ascending the rack on two adjacent rack supports by means of a frictional connection, using the two motor-driven friction wheels arranged in the friction wheel gauge for vertical friction wheel climbing on vertical surfaces of the two adjacent rack supports of the rack, the advantage is obtained that the rack supports themselves do not have to comprise perforations or additional mechanical devices such as gear racks or the like to enable the shuttle to be coupled in or, respectively, attached on the rack supports. Due to the friction wheels and the first pair of counterpressure wheels which, in the climbing position, are arranged in a counterpressure wheel gauge essentially corresponding to the friction wheel gauge in the climbing position, the shuttle is enabled to provide sufficient grip on the respective rack support solely due to the static friction of the friction wheels and to perform a vertical ascent and a decelerated descent along the rack supports. The displaceability of the counterpressure wheels between the docking position and the climbing position enables the shuttle to be coupled into or, respectively, onto the respective rack support after the shuttle has been positioned in front of the rack supports.

The counterpressure gauge of the counterpressure wheels is preferably smaller than the friction wheel gauge in the docking position, allowing the shuttle's counterpressure wheels to be inserted into the rack between the adjacent rack supports. By inserting the counterpressure wheels between the rack supports in the docking position and extending the counterpressure wheels into the climbing position, one rack support each is arranged at least in sections between, in each case, one friction wheel and at least one counterpressure wheel. This enables a mechanically particularly simple and robust mechanism of coupling in.

According to an alternative embodiment variant, the counterpressure wheels are pivotally mounted, and the shuttle control is designed for pivoting the counterpressure wheels from the docking position to the climbing position and from the climbing position to the docking position. As a result, a simple and robust mechanism of coupling in is likewise achieved.

The two friction wheels are preferably formed by two of the shuttle's several ground contact wheels. The advantage is thereby obtained that two of the ground contact wheels can be used simultaneously for ascending the rack supports. As a result, components of the shuttle can be eliminated, whereby the weight of the shuttle is reduced, the shuttle gets a simpler design and can be produced at lower cost.

According to a preferred embodiment variant of the storage system according to the invention, the friction wheels are adjustably mounted, and the shuttle control is designed for reducing an axial spacing between the friction wheels and the counterpressure wheels when the counterpressure wheels are adjusted to the climbing position, for pressing the friction wheels against the two adjacent rack supports, and for clamping the two adjacent rack supports, in each case at least in sections, between one of the friction wheels and one of the counterpressure wheels. As a result, a secure connection and high static friction between the rack supports and the friction wheels are achieved, due to a high normal force with which the friction wheels are pressed against the rack supports.

Particularly preferably, the friction wheels are adjustably mounted, and the shuttle control is designed for lifting the friction wheels from the rack supports when the counterpressure wheels are adjusted to their docking position. As a result, decoupling of the shuttle or, respectively, of the friction wheels from the rack supports is enabled.

According to an alternative embodiment of the storage system according to the invention, the counterpressure wheels are adjustably mounted, and the shuttle control is designed for reducing an axial spacing between the friction wheels and the counterpressure wheels when the counterpressure wheels are adjusted to their climbing position, and for pressing the counterpressure wheels against the two adjacent rack supports, and for clamping the two adjacent rack supports, in each case at least in sections, between one of the friction wheels and one of the counterpressure wheels. As a result, a high normal force acting on the friction wheels can likewise be generated.

In addition, according to an alternative embodiment variant, the counterpressure wheels can be adjustably mounted, and the shuttle control can be designed for lifting the counterpressure wheels from the rack supports when the counterpressure wheels are adjusted to their docking position. As a result, decoupling of the shuttle from the rack supports is likewise enabled.

Each of the friction wheels preferably has a ground contact surface and a rack support contact surface, with the friction wheel having a larger rolling circumference in the area of the ground contact surface than in the area of the rack support contact surface. As a result, the advantage is obtained that the respective friction wheel is movable on a subsurface using the ground contact surface and is movable on the vertical surface of the rack support using the rack support contact surface. In this way, the rack support contact surface does not get soiled by journeys of the shuttle on the potentially contaminated ground or, respectively, subsurface beneath the rack.

According to the preferred embodiment variant of the storage system according to the invention, the shuttle comprises a second pair of counterpressure wheels, which are arranged at a distance from the first pair of counterpressure wheels. A more even load distribution on the rack supports is thereby achieved.

Preferably, in the climbing position, the friction wheels and the first pair of counterpressure wheels are arranged substantially in a horizontal plane. As a result, a particularly high clamping force can be achieved while simultaneously preventing an excessive bending moment acting on the rack supports.

According to the preferred embodiment variant of the storage system according to the invention, the shuttle comprises a counterpressure wheel rocker with a rocker pivot point at a fixed end of the counterpressure wheel rocker and a free end arranged opposite the rocker pivot point. The free end of the counterpressure wheel rocker is preferably connected to a spring bearing of the counterpressure wheel rocker, and the first pair of counterpressure wheels is arranged in the area of the free end of the counterpressure wheel rocker. As a result, the advantage is obtained that a uniform clamping force Fₖ of the counterpressure wheels is provided by the spring bearing. Furthermore, irregularities along the rack supports can thereby be balanced out. In addition, the second pair of counterpressure wheels is preferably arranged in the area of the fixed end of the counterpressure wheel rocker.

Preferably, the cross-section of the rack supports essentially corresponds to a T-shape, at least in sections. As a result, the advantage is obtained that the rack supports can be manufactured easily and at low cost, while simultaneously exhibiting high load-bearing capacity and torsional rigidity. Furthermore, a good opportunity is thereby created for the friction wheels and the counterpressure wheels to clampingly engage the rack supports in the climbing position.

The storage system preferably comprises at least two shuttles, wherein the shuttles are designed for simultaneously accommodating, in the climbing position, the same rack support at least in sections between, in each case, at least one friction wheel and at least one counterpressure wheel, while being opposite to each other on a rack support, with the shuttles being movable past each other along the rack support. As a result, the advantage is obtained that shuttles moving vertically on the rack next to each other will not block each other. This leads to an increase in the storage and retrieval speed of the storage system according to the invention.

### BRIEF DESCRIPTION OF THE DRAWINGS

The automated storage system according to the invention, as well as preferred and alternative embodiment variants thereof, are explained in further detail below with reference to the figures.

FIG. 1a shows a shuttle of the storage system according to the invention in a preferred embodiment variant in a perspective view, with counterpressure wheels arranged in a docking position.

FIG. 1b shows the shuttle according to FIG. 1a in a side view.

FIG. 1c shows the shuttle according to FIG. 1a in a top view.

FIG. 2a shows the shuttle of the storage system according to the invention in a perspective view, with counterpressure wheels arranged in a climbing position.

FIG. 2b shows the shuttle according to FIG. 2a in a top view.

FIG. 3a shows the shuttle of the storage system according to the invention in a perspective view, with counterpressure wheels arranged in a climbing position, wherein an axial spacing between friction wheels of the shuttle and the counterpressure wheels has additionally been reduced.

FIG. 3b shows the shuttle according to FIG. 3a in a side view.

FIG. 3c shows the shuttle according to FIG. 3a in a top view.

FIG. 4 shows a detailed view of a counterpressure wheel rocker of the shuttle.

FIG. 5 shows two shuttles arranged next to each other adjacent to the same rack support.

FIG. 6 shows a rack support of the storage system according to the invention in a perspective view.

### DETAILED DESCRIPTION

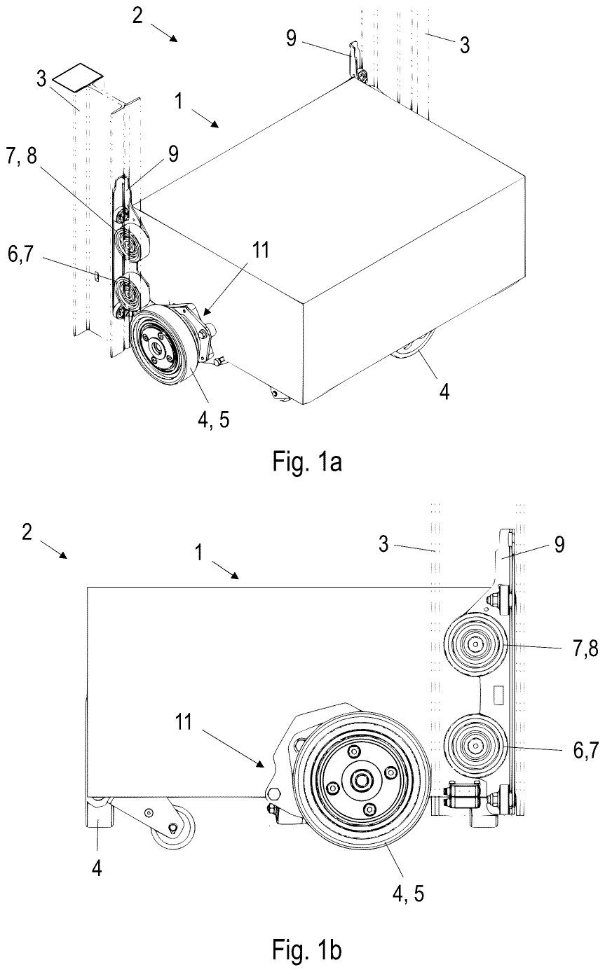

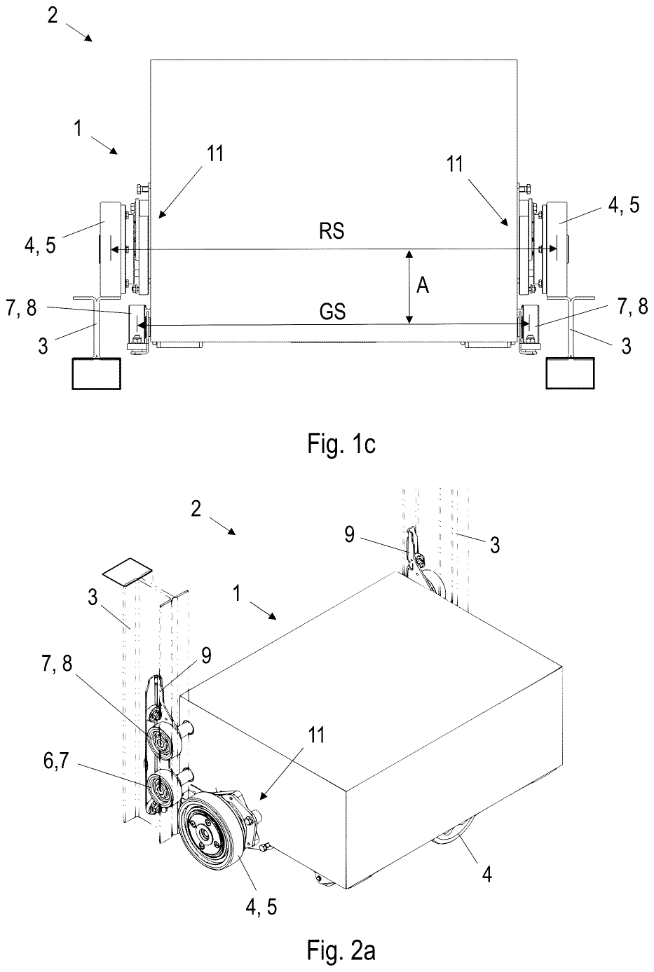

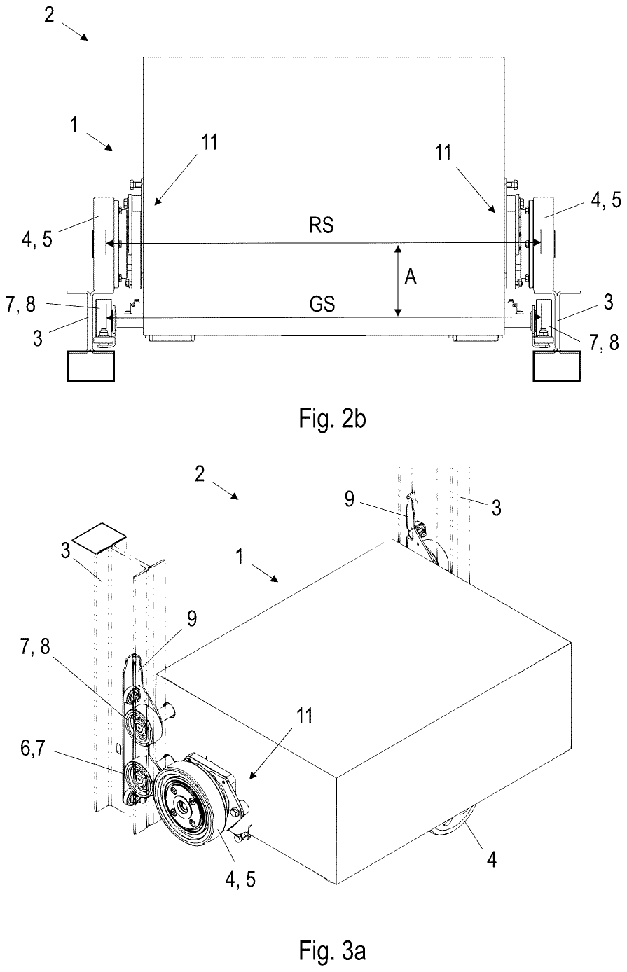

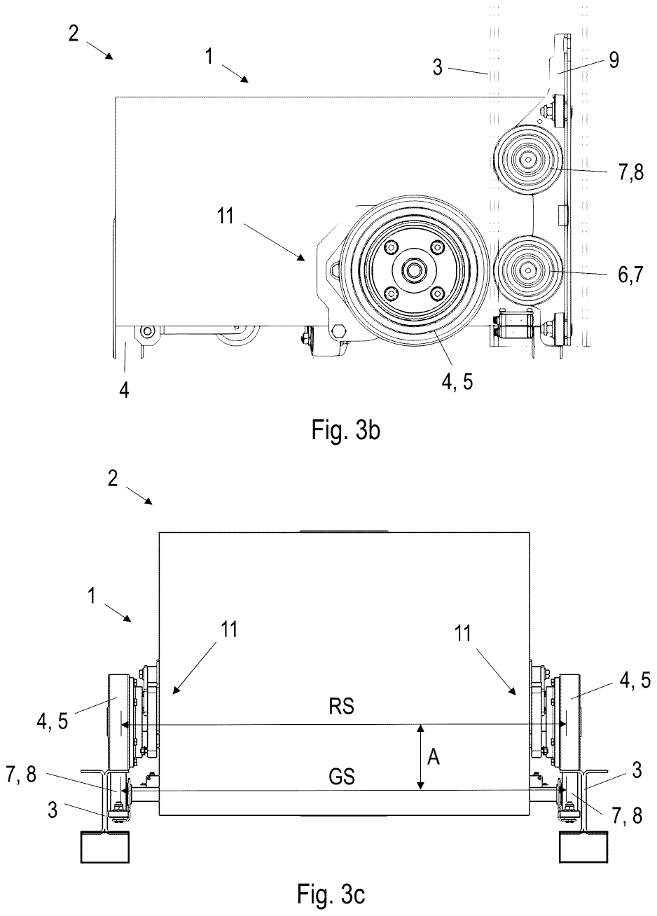

FIG. 1a shows a shuttle 1 of a storage system 2 according to the invention in a preferred embodiment variant. To comprehensively illustrate the structural details of the shuttle 1. FIG. 1b furthermore shows the shuttle according to FIG. 1a in a side view, and FIG. 1c shows the shuttle 1 according to FIG. 1a in a plan view. The storage system 2 according to the invention comprises at least one shuttle 1 for transporting storage aids, which are not depicted in the figures, and at least one rack placed on a subsurface and comprising several rack supports 3. FIG. 1a shows the shuttle 1 in a position on the subsurface, which is not separately illustrated in the figures. The shuttle 1 is designed for moving on the subsurface and for vertically ascending the rack on two adjacent rack supports 3 by means of a frictional connection. For this purpose, the shuttle 1 comprises a plurality of ground contact wheels 4 for moving the shuttle 1 on the subsurface and two motor-driven friction wheels 5 arranged in a friction wheel gauge RS, as can be seen in FIG. 1c, for vertical friction wheel climbing on vertical surfaces of the two adjacent rack supports 3 of the rack. Furthermore, the shuttle 1 comprises at least one load handling device, which is not separately illustrated in the figures, for receiving the storage aid, which likewise is not visible. In addition the shuttle 1 comprises a first pair 6 of counterpressure wheels 7. The counterpressure wheels 7 are displaceable by a shuttle control of the shuttle 1 between a docking position, which is illustrated in FIGS. 1a to 1c, and a climbing position, which can be seen in FIGS. 2a to 3c. The shuttle 2 is coupled to the two adjacent rack supports 3 in said climbing position, and the shuttle 1 is detached from the two adjacent rack supports 3 in the docking position. In the climbing position, the counterpressure wheels 7 are furthermore arranged in a counterpressure wheel gauge GS essentially corresponding to the friction wheel gauge RS, wherein, in the climbing position, one rack support 3 each is arranged at least in sections between one of the friction wheels 5 and one of the counterpressure wheels 7. This can be seen in FIGS. 2b and 3c. In the docking position, the counterpressure wheels 7 are positioned out of engagement with the rack supports 3, as can be seen in FIG. 1c. In the climbing position, the dead weight G of the shuttle 1 enables the counterpressure wheels 7 and the friction wheels 8 to rest against the vertical surfaces of the rack supports 3 when a torque is provided on the friction wheels 5, which is generated, for example, by a motor of the shuttle 1, as a result of the shuttle 1 being tilted relative to the course of the rack supports 3. As a result, a normal force N on these vertical surfaces is generated, whereby the friction of the friction wheels 5 on the rack supports 3 is increased and the shuttle 1 is enabled to climb up and descend in a controlled manner along the rack supports 3. The dead weight G and the normal force N can be seen in FIG. 4.

According to a preferred embodiment variant of the storage system 2 according to the invention, the counterpressure gauge GS, as shown in FIG. 1c, is smaller than the friction wheel gauge RS in the docking position of the counterpressure wheels 7, allowing the shuttle's 1 counterpressure wheels 7 to be inserted into the rack between the adjacent rack supports 3. In the docking position, the counterpressure gauge GS is smaller than the friction wheel gauge RS according to this embodiment variant depicted in FIG. 1, and in the climbing position shown in FIGS. 2b and 3b in a view from above, the counterpressure wheel gauge GS essentially corresponds to the friction wheel gauge RS. The counterpressure wheel gauge GS is therefore variable according to this embodiment variant. As a result, the shuttle 1 with the counterpressure wheels 7 located in the docking position can be positioned between the two adjacent rack supports 3. Preferably, the friction wheel gauge RS furthermore essentially corresponds to a distance between the two adjacent rack supports 3 so that, during friction wheel climbing, the friction wheels 5 rest against the vertical surfaces of the two adjacent rack supports 3 of the rack. According to an alternative embodiment variant of the storage system 2 according to the invention, which is not illustrated in the figures, the counterpressure wheels 7 are pivotally mounted, and the shuttle control is designed for moving the counterpressure wheels 7 from the docking position to the climbing position and from the climbing position to the docking position. As a result, it is also achieved that one rack support 3 each is arranged at least in sections between one of the friction wheels 5 and one of the counterpressure wheels 7.

The two friction wheels 5 are preferably formed by two of the several ground contact wheels 4 of the shuttle. As a result, the two ground contact wheels 4 attain a dual function as a ground contact wheel 4 and a friction wheel 5, whereby the number of necessary components of the shuttle 1 is reduced.

As shown in FIGS. 3a to 3c, the friction wheels 5 are preferably adjustably mounted, and the shuttle control is designed for reducing an axial spacing A between the friction wheels 5 and the counterpressure wheels 7 when the counterpressure wheels 7 are adjusted to their climbing position, for pressing the friction wheels 5 against the two adjacent rack supports 3, and for clamping the two adjacent rack supports 3, in each case at least in sections, between one of the friction wheels 5 and one of the counterpressure wheels 7. This state is clearly visible in FIG. 3c, wherein, in this case, a section of the rack supports 3 is clamped by the counterpressure wheels 7 and the friction wheels 5. The adjustability of the friction wheels 5 is preferably ensured by means of an eccentric mechanism 11 to which the respective friction wheel is attached. The adjustability of the friction wheels 5 provides the advantage that a high clamping force Fₖ acting on the rack supports 3, as visible in FIG. 4, can be achieved by means of the friction wheels 5 and the first pair 6 of counterpressure wheels 7, whereby even heavy loads can be transported by the shuttle 1.

According to an embodiment variant of the storage system 2 according to the invention, which is not visible in the figures, the counterpressure wheels 7 are adjustably mounted, and the shuttle control is designed for reducing an axial spacing A between the friction wheels 5 and the counterpressure wheels 7 when the counterpressure wheels 7 are adjusted to their climbing position, and for pressing the counterpressure wheels 7 against the two adjacent rack supports 3, and for clamping the two adjacent rack supports 3, in each case at least in sections, between one of the friction wheels 5 and one of the counterpressure wheels 7. A simple and robust clamping system operating with conventional rack supports 3 constructed in a simple manner and at low cost, for example, from metal sheets is provided by such clamping methods, whereby the manufacturing and operating costs of the storage system 2 according to the invention are reduced.

Preferably, the friction wheels 5 are adjustably mounted, and the shuttle control is furthermore designed for lifting the friction wheels 5 from the rack supports 3 when the counterpressure wheels 7 are adjusted to their docking position. According to an alternative embodiment variant, which is not illustrated in the figures, the counterpressure wheels 7 are adjustably mounted, and the shuttle control is designed for lifting the counterpressure wheels 7 from the rack supports 3 when the counterpressure wheels 7 are adjusted to their docking position. Simple and rapid decoupling mechanisms are thereby provided.

According to the preferred embodiment variant of the storage system 2 according to the invention, each of the friction wheels 5 has a ground contact surface and a rack support contact surface, with the friction wheel 5 having a larger rolling circumference in the area of the ground contact surface than in the area of the rack support contact surface. This is not visible in the figures. As a result, the shuttle 1 can travel on the subsurface on the ground contact surface of the friction wheels 5, while the rack support contact surface rests against the respective vertical surface of the two adjacent rack supports 3 of the rack during friction wheel climbing along the rack supports 3. As a result, contaminations of the rack support contact surface are avoided, whereby a consistently high static friction between the rack support 3 and the friction wheel 5 can be achieved reliably.

As can be seen in the figures, in the preferred embodiment variant of the storage system 2 according to the invention, the shuttle 1 has a second pair 8 of counterpressure wheels 7, which is arranged at a distance from the first pair 6 of counterpressure wheels 7. An additional support for the shuttle 1 on the rack supports 3 is thereby provided. As can be seen in the figures, the friction wheels 5 and the first pair of counterpressure wheels 7 are arranged essentially in one plane in the climbing position. In this way, it is made sure that no deformation of the rack supports 3 occurs under a high clamping force.

The shuttle 1 preferably comprises a counterpressure wheel rocker 9 with a rocker pivot point at a fixed end 12 of the counterpressure wheel rocker 9 and a free end 13 arranged opposite the rocker pivot point. The counterpressure wheel rocker 9 is depicted in detail in FIG. 4. The free end 13 of the counterpressure wheel rocker 9 is connected to a spring bearing 14 of the counterpressure wheel rocker 9, and the first pair 6 of counterpressure wheels 7 is arranged in the area of the free end 13 of the counterpressure wheel rocker 9. A uniform clamping force between the first pair 6 of counterpressure wheels 7 and the friction wheels 5 is thereby provided. As can be seen in FIG. 4, the second pair 8 of counterpressure wheels 7 is preferably arranged in the area of the fixed end 12 of the counterpressure wheel rocker 9. Because of the weight of the shuttle 1, a lever action is thereby generated, which presses the second pair 8 of counterpressure wheels 7 against the rack supports 3.

As can be seen in FIG. 4, the second pair 8 of counterpressure wheels 7 is preferably positioned above the first pair 6 by a distance y, whereby the centre of gravity S of the shuttle 1, which projects by a distance x and in which the weight force G acts, increases the normal force N of the friction wheels 5 on the rack supports 3 by the lever force Fₕ according to the lever principle:

$$Fh = G * x / y$$

$$N = Fk + Fh$$

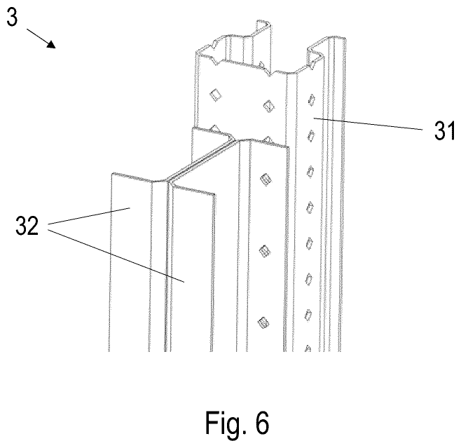

Preferably, the cross-section of the rack supports 3 has a section essentially corresponding to a T-shape. This can be seen, for example, in FIGS. 1a, 1c, 3a and 3c. As a result, the advantage is obtained that the rack supports 3 can be manufactured easily and at low cost, while simultaneously exhibiting high load-bearing capacity and torsional rigidity. Furthermore, a good opportunity is thereby created for the friction wheels 5 and the counterpressure wheels 7 to clampingly engage the rack supports 3 in the climbing position. The T-shaped section of the cross-section of the rack supports 3 is preferably implemented by a multi-part construction of the rack supports 3. For example, in the preferred embodiment variant illustrated in FIG. 6, the rack supports 3 of the storage system 2 according to the invention comprise a base profile 31 to which two C-profiles 32 arranged adjacent to each other on their longitudinal side, as seen in the cross-section, are attached in such a way that a base side of the C-profiles 32, as seen in the cross-section of the C-profiles 32, rests against the base profile 31. The T-shaped section of the cross-section of the rack supports 3 is thus formed by a section of the C-profiles 32 which is arranged opposite to the base profile 31.

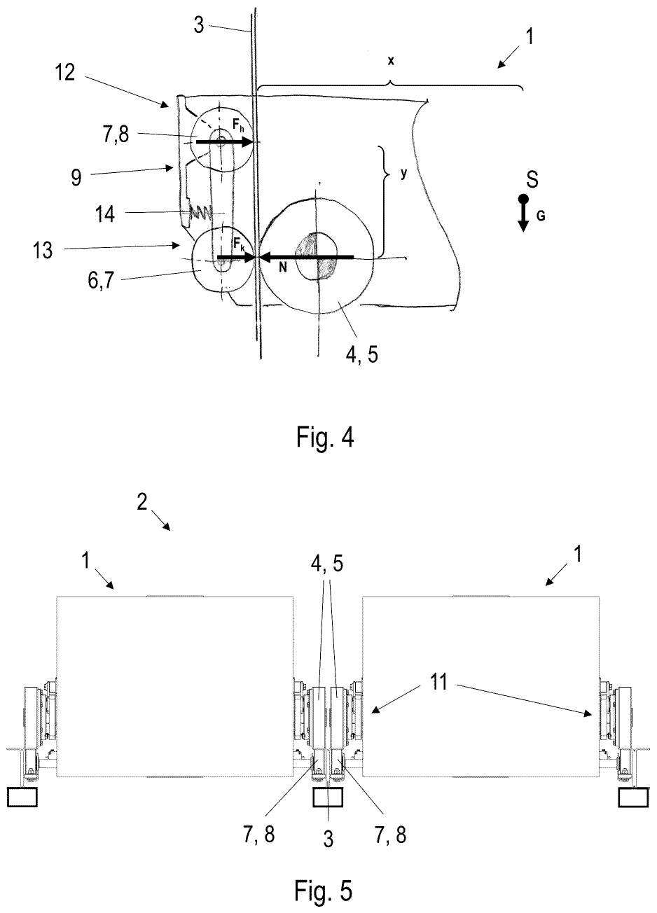

As can be seen in FIG. 5, the storage system 2 according to the invention preferably comprises at least two shuttles 1, wherein the shuttles 1 are designed for simultaneously accommodating, in the climbing position, the same rack support 3 at least in sections between, in each case, at least one friction wheel 5 and at least one counterpressure wheel 7, while being opposite to each other on a rack support 3, with the shuttles 1 being movable past each other along the rack support 3. As a result, the advantage is obtained that shuttles 1 moving vertically on the rack next to each other will not block each other. This leads to an increase in the storage and retrieval speed of the storage system 2 according to the invention. For example, as can be seen in FIG. 5, the shuttles 1 can each clamp a section of the shared rack support 3 between, in each case, one of their friction wheels 5 and one of their counterpressure wheels 7 and can be moved past each other in a climbing manner. This section preferably has a T-shaped design, when viewed in the cross-section of the rack support.

In the storage system 1 according to the invention, as well as in storage systems according to the prior art, the storage speed can be increased by a method of storing and/or retrieving goods in or out of a storage space of a storage system 2, wherein the storage system 2 comprises a rack placed on a subsurface and comprising several rack supports 3 and at least two shuttles 1. The method can be described as follows, for example.

A method of storing and/or retrieving goods in or out of a storage space of a storage system 2, wherein the storage system 2 comprises a rack placed on a subsurface and comprising several rack supports 3 and at least two shuttles 1, each of the shuttles 1 being vertically movable on vertical surfaces of two adjacent rack supports 3 of the rack, comprising the steps of:
Vertical friction wheel climbing of the respective shuttle 1 along the two adjacent rack supports 3 of the rack, and
Moving two shuttles 1 arranged opposite to each other on a rack support 3 past each other during the vertical friction wheel climbing of the shuttles 1.

Due to this method, the advantage is obtained that the shuttles 1 can use any adjacent rack supports 3 to ascend the rack, without having to consider whether another shuttle 1 adjacent to these rack supports 3 also already ascends the rack or climbs down on it. The storage and retrieval speed is thereby increased significantly in comparison to methods according to the prior art.

1-15. (canceled)

16. An automated storage system with a shuttle operable to transport storage aids and at least one rack placed on a subsurface and comprising rack supports, the shuttle configured to move on the subsurface and to vertically ascend the rack on two adjacent rack supports by a frictional connection, and the shuttle comprising:
a plurality of ground contact wheels configured to move the shuttle on the subsurface; at least one load handling device configured to receive the storage aid;
two motor-driven friction wheels arranged in a friction wheel gauge to enable vertical friction wheel climbing on vertical surfaces of the two adjacent rack supports of the rack; and a first pair of counterpressure wheels, wherein:
the counterpressure wheels are displaceable by a shuttle control of the shuttle between a docking position and a climbing position, and the shuttle is coupled to the two adjacent rack supports in the climbing position and the shuttle is detached from the two adjacent rack supports in the docking position,
wherein, in the climbing position, the counterpressure wheels are arranged in a counterpressure wheel gauge essentially corresponding to the friction wheel gauge, and one rack support each is arranged at least in sections between one of the friction wheels and one of the counterpressure wheels,
and wherein, in the docking position, the counterpressure wheels are positioned out of engagement with the rack supports,
wherein the shuttle comprises a second pair of counterpressure wheels, which are arranged at a distance from the first pair of counterpressure wheels.

17. The automated storage system according to claim 16, wherein the counterpressure gauge of the counterpressure wheels is smaller than the friction wheel gauge in the docking position, allowing the shuttle's counterpressure wheels to be inserted into the rack between the adjacent rack supports.

18. The automated storage system according to claim 16, wherein the counterpressure wheels are pivotally mounted, and the shuttle control configured to pivot the counterpressure wheels from the docking position to the climbing position and from the climbing position to the docking position.

19. The automated storage system according to claim 16, wherein the two friction wheels are formed by two of the shuttle's several ground contact wheels.

20. The automated storage system according to claim 16, wherein the friction wheels are adjustably mounted, and the shuttle control is configured to reduce an axial spacing between the friction wheels and the counterpressure wheels when the counterpressure wheels are adjusted to the climbing position, to press the friction wheels against the two adjacent rack supports, and to clamp the two adjacent rack supports, in each case at least in sections, between one of the friction wheels and one of the counterpressure wheels.

21. The automated storage system according to claim 16, wherein the friction wheels are adjustably mounted, and that the shuttle control is configured to lift the friction wheels from the rack supports when the counterpressure wheels are adjusted to their docking position.

22. The automated storage system according to claim 16, wherein the counterpressure wheels are adjustably mounted, and the shuttle control is configured to reduce an axial spacing between the friction wheels and the counterpressure wheels when the counterpressure wheels are adjusted to their climbing position, and to press the counterpressure wheels against the two adjacent rack supports, and to clamp the two adjacent rack supports, in each case at least in sections, between one of the friction wheels and one of the counterpressure wheels.

23. The automated storage system according to claim 16, wherein the counterpressure wheels are adjustably mounted, and that the shuttle control is configured to lift the counterpressure wheels from the rack supports when the counterpressure wheels are adjusted to their docking position.

24. The automated storage system according to claim 16, wherein each of the friction wheels has a ground contact surface and a rack support contact surface, with the friction wheel having a larger rolling circumference in the area of the ground contact surface than in the area of the rack support contact surface.

25. The automated storage system according to claim 16, wherein, in the climbing position, the friction wheels and the first pair of counterpressure wheels are arranged substantially in a horizontal plane.

26. The automated storage system according to claim 16, wherein the shuttle comprises a counterpressure wheel rocker with a rocker pivot point at a fixed end of the counterpressure wheel rocker and a free end arranged opposite the rocker pivot point, the free end of the counterpressure wheel rocker being connected to a spring bearing of the counterpressure wheel rocker, and the first pair of counterpressure wheels is arranged in the area of the free end of the counterpressure wheel rocker.

27. The automated storage system according to claim 16, wherein the second pair of counterpressure wheels is arranged in the area of the fixed end of the counterpressure wheel rocker.

28. The automated storage system according to claim 16, wherein a cross-section of the rack supports corresponds to a T-shape, at least in sections.

29. The automated storage system according to claim 16, wherein the storage system comprises at least two shuttles, wherein the shuttles configured to simultaneously accommodate, in the climbing position, the same rack support at least in sections between, in each case, at least one friction wheel and at least one counterpressure wheel, while being opposite to each other on a rack support, with the shuttles being movable past each other along the rack support.
